(19) United States
(12) Patent Application Publication
(10) Pub. No.: US 2008/0240397 A1
(43) Pub. Date: Oct. 2, 2008

(54) White page and yellow page directories in a geo-spatial environment

(75) Inventor: Raj Vasant Abhyanker, Cupertino, CA (US)

Correspondence Address: PILLSBURY WINTHROP SHAW PITTMAN LLP, P.O. BOX 10500, MCLEAN, VA, 22102, US

(73) Assignee: Fatdoor, Inc.

(21) Appl. No.: 11/731,465

(22) Filed: Mar. 29, 2007

(51) Int. Cl. H04M 3/42

(52) U.S. Cl. 379/218.01

(57) ABSTRACT

A method, apparatus and system of white page and yellow page directories in a geo-spatial environment are disclosed. In one embodiment, a method includes geo-coding an address data associated with a listing of a directory on a map and publishing an inventory of a user associated with the listing to market to other users and residents a threshold distance away from the address data associated with the listing. The method may include generating a set of coupons of a business associated with the listing as the inventory, and providing the set of coupons to the other users and residents the threshold distance away from the address data associated with the listing. The method may also include adjusting the threshold distance away based on a request of the user associated with the listing.

### FIELD OF TECHNOLOGY

This disclosure relates generally to the technical fields of communications and, in one example embodiment, to a method, apparatus, and system of white page and yellow page directories in a geo-spatial environment.

### BACKGROUND

A directory (e.g., yellow pages, white pages, online directories) may be available as a marketing resource to enable and to enhance commerce. Generally, the directory may provide information (e.g., names, phone numbers, addresses, office location, etc.) on listings (e.g., people, businesses, parks, churches, etc.) which may be categorized based on various criteria (e.g., on products, services, names, geographical locations, age, culture, etc.). The directory may primarily include residential listings (e.g., a white page directory). Alternately, the directory may primarily include business listings (e.g., a yellow page directory). The directory may be difficult and cumbersome to search through because of its physical size. In addition, printing, mailing, producing, updating and distributing the directory can be very expensive.

A user may not know by looking at the directory how far or close things are from the user's present location. As such, the user may need to separately consult a map to see how far locations are from his or her present location. To get accurate directions, the user may need to enter in a starting point and a destination point (e.g., the listing in the directory) in the map (e.g., MapQuest®, Yahoo® Maps, Google® Maps). In addition, the user may not know about current coupons, specials, discounts, and happenings at business listings in the directory. Information in the directory may be limited and out of date because it may have been published weeks before the user reads the directory.

### SUMMARY

A method, apparatus and system of white page and yellow page directories in a geo-spatial environment are disclosed. In one aspect, a method includes geo-coding an address data associated with a listing of a directory (e.g., the directory may be a people directory, a business directory, a telephone directory, a yellow page directory, a white page directory, and/or an address directory) on a map, and publishing an inventory of a user associated with the listing to market to other users and residents a threshold distance away from the address data associated with the listing.

The method may further include generating a set of coupons of a business associated with the listing as the inventory, and providing the set of coupons to the other users and/or residents the threshold distance away from the address data associated with the listing. The method may also include adjusting the threshold distance away based on a request of the user associated with the listing. The method may include generating an excess inventory of a residential household as the inventory, and providing access to published ones of the excess inventory to the other users and/or residents the threshold distance away from the address data associated with the listing.

In addition, the method may include generating a neighborhood view in the map that simultaneously displays the address data and the listing data as a profile above an aerial imagery of a neighborhood encompassing the address data along with neighboring profiles associated with adjacent address data and/or adjacent listing data to the profile. The method may include providing a wiki interface to each of the profiles in the neighborhood view such that each profile may be editable by the user and the other users until the profiles are claimed by a legitimate entity (e.g., the legitimate entity may be a business user and/or a residential user whose information is represented in the profile) entitled to control of content of each profile.

The method may include communicating between the user and the residents through a direct mail builder application that generates a postal mailer deliverable to the residents upon a request of the user. In addition, the method may include forming a group mailer (e.g., the group mailer may include a coupon book, a specials guide, a community publication, a political mailer, and/or an advertisement) through an aggregation of numerous postal mailers that may be simultaneously sent through a common postage such that the group mailer includes messages of any number of users associated with different listings, and/or the group mailer.

The method may also include automatically scanning the directory and/or performing an optical character recognition methodology on the directory using a directory scanner which automatically decouples pages of a printed one of the directory and scans the directory into a geo-spatial database. The method may include geo-coding a contact data associated with each listing such that users across different neighborhoods, cities, regions, countries, and/or continents telephone each other through a single click in a geo-spatial social network embodying any number of the listings.

Also, the method may include providing an interface such that any visitor to a geo-spatial directory automatically updates the address data and/or the listing data through a wiki interface, and such that any visitor to the geo-spatial directory contributes content to the listing in the form of a photographic tag, a textual tag, and/or a video tag associated with the listing. The method may include enabling the user to contribute interesting data for submission in a landing page associated with users of a geo-spatial social network embodying each listing of the directory in the map.

In another aspect, a method includes providing a context to a legacy telephone directory data by geo-coding the legacy telephone directory data in a geo-spatial directory that simultaneously renders each listing of the legacy telephone directory in a map along with adjacent listings, creating a wiki interface such that any user of the geo-spatial directory updates the legacy telephone directory data until specific listings of the legacy telephone directory data is claimed by identified parties in the listings and creating a landing page for users of the geo-spatial directory such that the landing page reflects coupons, new events, and/or activity among advertisers, businesses, and/or residents of a neighborhood in which the users may be domiciled.

The method may further include relocating a set of pushpins representing each of the specific listings of the legacy telephone directory through the wiki interface such that users of the wiki interface alter a position estimate generated and visualized through a block interpolation algorithm to a more accurate rooftop location of a particular listing in the legacy telephone directory now transformed into the geo-spatial directory. In addition, the method may include automatically generating directions (e.g., the directions may be a walking directions, a driving directions, a commuting directions, a subway route and timing directions, a bus route and timing directions, a train route and timing directions, and/or a plane route and timing directions) between a user of the geo-spatial directory and the listing based on a stored address data associated with a profile of the user in the geo-spatial directory that determines a starting location of the user without requiring input of the starting location of the user when generating the directions.

In yet another aspect, a system includes an information module having a yellow page data and/or a white page data that may be geo-spatially tagged in a geo-spatial directory, a scanning device to transform a telephone directory into a form that may be geo-spatially tagged in the geo-spatial directory, a wiki module to provide to make editable each listing of the telephone directory until each listing is claimed, and a map module to simultaneously display adjacent locations listed in the telephone directory in a three-dimensional map view taken through an aerial photography and/or a satellite imagery.

In addition, the system may include a landing module to generate a home page of a neighbor who logs into the geo-spatial directory to learn about and/or explore new and changing events (e.g., the new and changing events may be new people in a neighborhood, users who have viewed a profile of the neighbor, and changing business profiles and special offers in the neighborhood) in their neighborhood.

The methods, systems, and apparatuses disclosed herein may be implemented in any means for achieving various aspects, and may be executed in a form of a machine-readable medium embodying a set of instructions that, when executed by a machine, cause the machine to perform any of the operations disclosed herein. Other features will be apparent from the accompanying drawings and from the detailed description that follows.

### BRIEF DESCRIPTION OF THE DRAWINGS

Example embodiments are illustrated by way of example and not limitation in the figures of the accompanying drawings, in which like references indicate similar elements and in which:

FIG. 1 is a system view of a geo-spatial directory communicating with a neighborhood through a network, according to one embodiment.

FIG. 2 is a schematic representation of accessing a yellow page/white page database, according to one embodiment.

FIG. 3 is a global map view of digitizing yellow pages and white pages, according to one embodiment.

FIG. 4 is a user interface view of white pages in the geo-spatial directory, according to one embodiment.

FIG. 5 is a user interface view of yellow pages in a geo-spatial directory, according to one embodiment.

FIG. 6 is a user interface view of the information module of FIG. 1, according to one embodiment.

FIG. 7 is a diagrammatic system view of a data processing system in which any of the embodiments disclosed herein may be performed, according to one embodiment.

FIG. 8 is a table view showing details of a geo-spatially tagged listing associated with businesses in the neighborhood, according to one embodiment.

FIG. 9 is a table view showing details of a geo-spatially tagged listing associated with residents in the neighborhood, according to one embodiment.

FIG. 10 is a schematic diagrammatic view of a directory scanner, according to one embodiment.

FIG. 11A is a process flow of geo-coding an address data associated with a listing of a directory on a map, according to one embodiment.

FIG. 11B is a continuation of the process flow of FIG. 11A, showing additional processes, according to one embodiment.

FIG. 12 is a process flow of geo-coding legacy telephone directory data in the geo-spatial directory, according to one embodiment.

Other features of the present embodiments will be apparent from the accompanying drawings and from the detailed description that follows.

### DETAILED DESCRIPTION

A method, apparatus and system of white page and yellow page directories in a geo-spatial environment are disclosed. In the following description, for the purposes of explanation, numerous specific details are set forth in order to provide a thorough understanding of the various embodiments. It will be evident, however to one skilled in the art that the various embodiments may be practiced without these specific details.

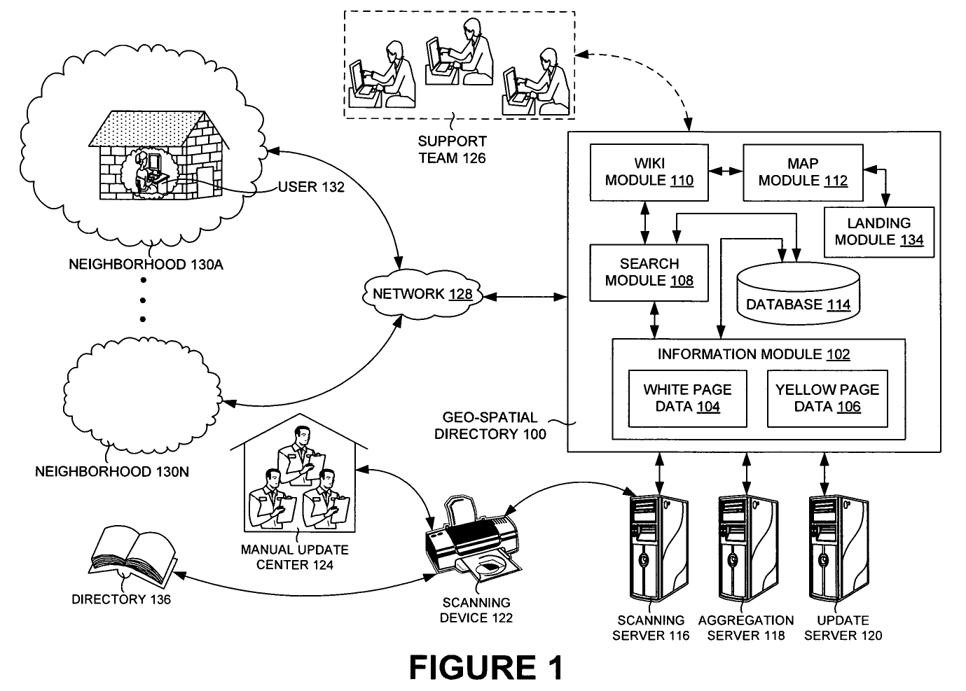

In one embodiment, a method includes geo-coding an address data associated with a listing of a directory on a map and publishing an inventory of a user (e.g., the user 132 of FIG. 1) associated with the listing to market to other users and residents a threshold distance away from the address data associated with the listing.

In another embodiment, a method includes providing a context to a legacy telephone directory data by geo-coding the legacy telephone directory data in a geo-spatial directory (e.g., the geo-spatial directory 100 of FIG. 1) that simultaneously renders each listing of the legacy telephone directory data in a map along with adjacent listings, creating a wiki interface such that any user of the geo-spatial directory updates (e.g., the user may update the geo-spatial directory through the manual update center 124 of FIG. 1) the legacy telephone directory data until specific listings of the legacy telephone directory data is claimed by identified parties in the listings and creating a landing page for users of the geo-spatial directory 100 such that the landing page reflects coupons, new events, and/or activity among advertisers, businesses, and/or residents of a neighborhood (e.g., the neighborhood 130A-N of FIG. 1) in which the users are domiciled.

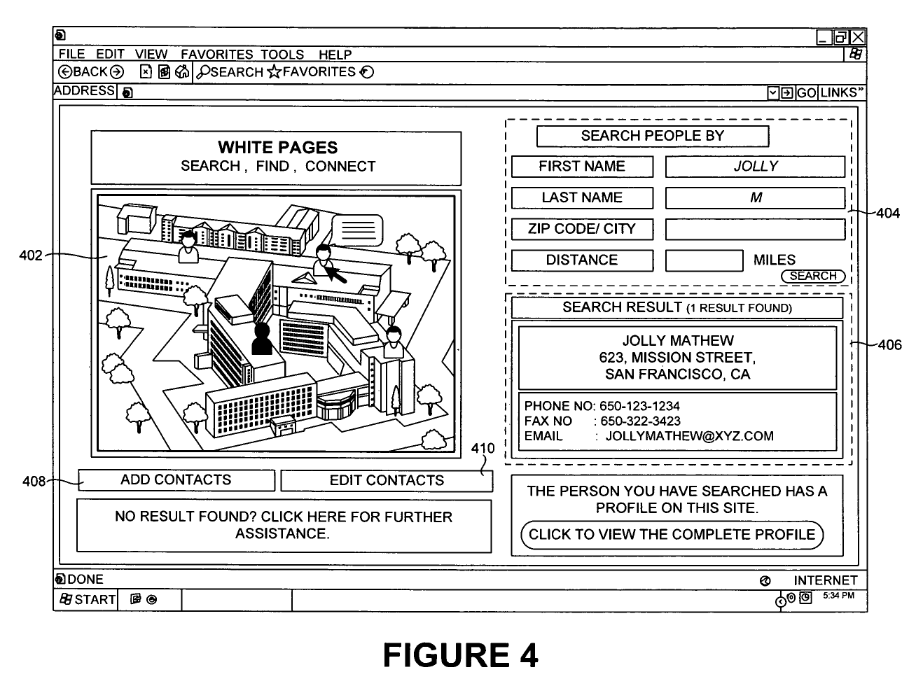

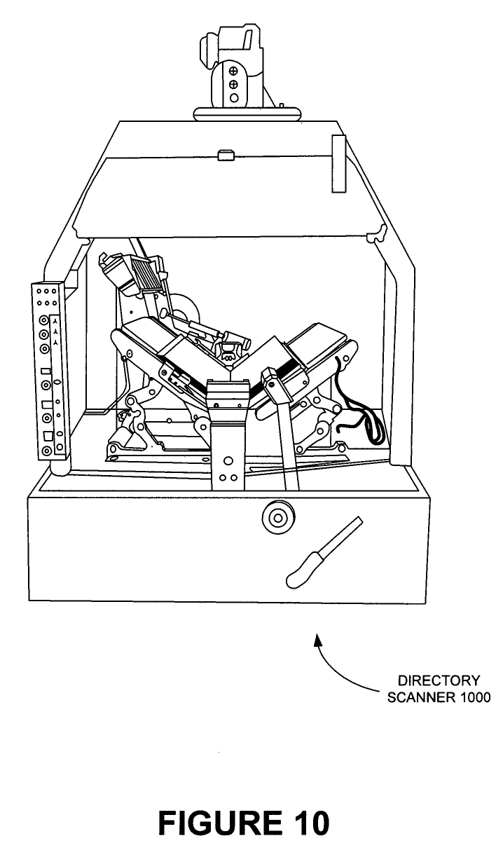

In yet another embodiment, a system includes the information module (e.g., the information module 102 of FIG. 1) having a yellow page data (e.g., the yellow page data 106 of FIG. 1) and/or a white page data (e.g., the white page data 104 of FIG. 1) that is geo-spatially tagged in the geo-spatial directory 100, a scanning device (e.g., the directory scanner 1000 of FIG. 10) to transform a telephone directory into a form that may be geo-spatially tagged in the geo-spatial directory 100, a wiki module (e.g., the wiki module 110 of FIG. 1) to make editable (e.g., the user can edit the listing through a wiki interface) each listing of the telephone directory until each listing is claimed and a map module (e.g., the map module 112 of FIG. 1) to simultaneously display adjacent locations listed in the telephone directory in a three-dimensional map view (e.g., the three-dimensional map view 402 of FIG. 4) taken through an aerial photography and/or a satellite imagery.

FIG. 1 is a system view of a geo-spatial directory 100 communicating with a neighborhood(s) 130A-N through a network 128, according to one embodiment. Particularly, FIG. 1 illustrates the geo-spatial directory 100, an information module 102, a white page data 104, a yellow page data 106, a search module 108, a wiki module 110, a map module 112, a database 114, a scanning server 116, an aggregation server 118, an update server 120, a scanning device 122, a manual update center 124, a support team 126, the network 128, the neighborhood(s) 130A-N, a user 132, a landing module 134 and a directory 136, according to one embodiment.

The geo-spatial directory 100 may contain a listing (e.g., business and residential listings) associated with an address data of the user 132 geo-coded on a map (e.g., the three-dimensional neighborhood map 402 of FIG. 4). The information module 102 may generate the listing associated with businesses and residences in the neighborhood 130A-N. The white page data 104 may contain a listing such as residential subscriber names, addresses and telephone numbers associated with the residents in the neighborhood 130A-N. The yellow page data 106 may contain listing information associated with the businesses categorized according to products and/or services provided. The search module 108 may enable a people search, a business search and/or a place search associated with a query requested by the user in the neighborhood 130A-N.

The wiki module 110 may provide a wiki interface such that the users of the geo-spatial directory 100 edit and/or update the listing and/or the address data associated with the user profile until each listing is claimed. Also, the wiki module 110 may provide an interface where a set of markers (e.g., pushpins) representing each of the specific listings may be relocated by the users to a more accurate rooftop location associated with the listing in the geo-spatial directory 100. The map module 112 may display a three-dimensional map (e.g., the three-dimensional map view 402 of FIG. 4) associated with the listing in the geo-spatial directory 100. The database 114 may contain information (e.g., content data, address data, etc.) associated with the residents and/or businesses in the neighborhood 130A-N which is geo-spatially tagged in the geo-spatial directory 100. The scanning server 116 may enable scanning and tagging the listing geo-spatially into the geo-spatial directory 100.

The aggregation server 118 may enable aggregation of numerous postal mailers sent to the residents in the neighborhood upon a request of the user 132. The update server 120 may record updated listing and/or the address data associated with the user in the geo-spatial database (e.g., the database 114 of FIG. 1). The scanning device 122 may automatically decouple the printed pages of the directory and scan the directory into the geo-spatial database. The manual update center 124 may enable the visitors to update the listing and/or the address data through the wiki interface provided by the wiki module 110.

The support team 126 may be any visitor of the geo-spatial directory who may add and/or update the listings in the geo-spatial directory 100. The network 128 may be a social network and/or a business network which enables the residents and/or businesses in the neighborhood 130A-N to communicate with each other. The neighborhood 130A-N may be a geographically localized community in a larger city, a town and/or a suburb. The user 132 may be a resident of the neighborhood 130A-N who may access listing geo-spatially tagged in the geo-spatial directory 100 to communicate with the residents and/or the businesses in the neighborhood 130A-N.

The landing module 134 may generate a landing page (e.g., a home page) that reflects events, activities, advertisements and/or coupons among advertisers, the businesses and/or residences in the neighborhood 130A-N. The directory 136 may be a legacy telephone directory, a business directory, a people directory, a yellow page directory, a white page directory, an address directory which is geo-spatially tagged to the geo-spatial directory 100 using the scanning server 116 and the scanning device 122.

In the example embodiment illustrated in FIG. 1, the geo-spatial directory 100 communicates with the neighborhood 130A-N through the network 128. In addition, the geo-spatial directory 100 communicates with the scanning server 116, the aggregation server 118 and the update server 120. The information module 102 may contain the white page data 104, and the yellow page data 106. The scanning server 116 communicates with the manual update center 124 through a scanning device 122. The support team 126 communicates with the geo-spatial directory 100.

The address data associated with the listing of the directory 136 may be geo-coded on the map. In addition, an inventory of the user 132 associated with the listing may be published to market to the other users and/or residents a threshold distance away from the address data associated with the listing. A set of coupons of the business associated with the listing may be generated as the inventory. Further, the set of coupons may be provided to the other users and/or residents the threshold distance away from the address data associated with the listing. Also, the threshold distance away may be adjusted based on a request of the user associated with the listing.

A neighborhood view (e.g., the three-dimensional neighborhood map view 402 of FIG. 4) may be generated in the map to simultaneously display the address data and/or the listing data as a profile above an aerial imagery of a neighborhood (e.g., the neighborhood 130A-N of FIG. 1) encompassing the address data along with neighboring profiles associated with adjacent address data and adjacent listing data to the profile. Additionally, a wiki interface may be provided to each of the profiles in the neighborhood view such that each profile is editable by the user and/or the other users until the profiles are claimed by a legitimate entity (e.g., a business user and a residential user whose information is represented in the profile) entitled to control of content of each profile.

The user and the residents may communicate through a direct mail builder application that generates the postal mailer deliverable to the residents upon a request of the user. In addition, a group mailer (e.g., a coupon book, a specials guide, a community publication, a political mailer, an advertisement, etc.) may be formed through an aggregation of numerous postal mailers that are simultaneously sent through a common postage such that the group mailer includes messages of the users associated with different listings.

The directory 136 (e.g., the people directory, the business directory, the telephone directory, the yellow page directory, the white page directory and/or the address directory, etc.) may be scanned automatically and the optical character recognition (e.g., OCR) methodology may be performed on the directory using a directory scanner (e.g., the directory scanner 1000 of FIG. 10) which automatically decouples pages of a printed directory (e.g., the directory 136 of FIG. 1) and/or scans the directory 136 into the geo-spatial database (e.g., the database 114 of FIG. 1).

A contact data associated with each listing may be geo-coded such that users across different neighborhoods, cities, regions, countries, and/or continents telephone each other through a single click in a geo-spatial social network embodying a number of listings. The user (e.g., the user 132 of FIG. 1) may be enabled to contribute interesting data (e.g., coupons, events, advertisements, etc.) for submission in the landing (e.g., login, home, etc.) page associated with users of the geo-spatial social network embodying each listing of the directory in the map.

A context may be provided to a legacy telephone directory data by geo-coding the legacy telephone directory data in the geo-spatial directory 100 to simultaneously render each listing of the legacy telephone directory data in the map along with adjacent listings. In addition, a wiki interface may be created such that any user of the geo-spatial directory 100 updates the legacy telephone directory data until specific listings of the legacy telephone directory data are claimed by identified parties in the listings. A landing page may be created for the users (e.g., the user 132 of FIG. 1) of the geo-spatial directory 100 such that the landing page reflects coupons, new events, and/or activity among advertisers, businesses, and/or residents of the neighborhood 130A-N in which the users are domiciled.

The information module 102 may process the yellow page data 106 and/or the white page data 104 that is geo-spatially tagged in the geo-spatial directory 100. The scanning device 122 may transform a telephone directory into a form that is geo-spatially tagged in the geo-spatial directory 100. The wiki module 110 may be provided to make editable each listing of a telephone directory until each listing is claimed. The map module 112 may simultaneously display adjacent locations listed in the telephone directory in the three-dimensional map view (e.g., the three-dimensional map view 402 of FIG. 4) taken through aerial photography and/or satellite imagery.

The landing module 134 may generate a home page of a neighbor who logs into the geo-spatial directory to learn about and explore new and changing events (e.g., one of new people in the neighborhood 130A-N, users who have viewed a profile of the neighbor, and changing business profiles and special offers in the neighborhood 130A-N) in their neighborhood 130A-N.

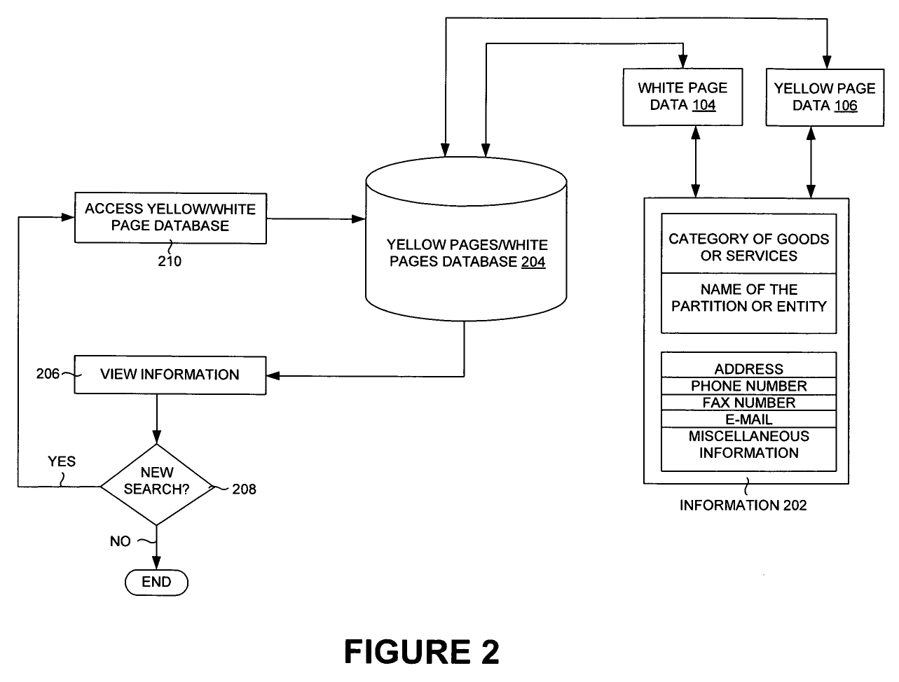

FIG. 2 is a schematic representation of accessing a yellow page/white page database 204, according to one embodiment. Particularly, FIG. 2 illustrates a white page data 104, a yellow page data 106, information 202, the yellow page/white page database 204, an operation 206, an operation 208, and an operation 210, according to one embodiment.

The information 202 may be data available in the yellow page/white page database 204 which is accessed by the users of the geo-spatial directory (e.g., the geo-spatial directory 100 of FIG. 1). The yellow page/white page database 204 may be a geo-spatial database in which content data, listing and the address data of the businesses and/or residents are stored, and/or updated and may be accessed by the users of the geo-spatial directory. The operation 206 may involve visualizing relevant information stored in the yellow page/white page database 204 requested by the user of the geo-spatial directory 100.

The operation 208 may determine whether the user of the geo-spatial directory 100 wishes to perform a new search or not. If the user of the geo-spatial directory 100 does not wish to perform the new search then the search process may be terminated. The operation 210 may enable the user of the geo-spatial directory 100 to access the listings and/or the address data associated with the residents and/or businesses from the yellow page/white page database 204.

In example embodiment illustrated in FIG. 2, the users of the geo-spatial directory 100 access the information 202 (e.g., the information associated with the residential listing and/or business listings) available in the yellow page/white page database 204 through a search query.

An excess inventory of a residential household may be generated as the inventory. In addition, access to published ones of the excess inventory may be provided to the other users and/or residents, a threshold distance away from the address data associated with the listing.

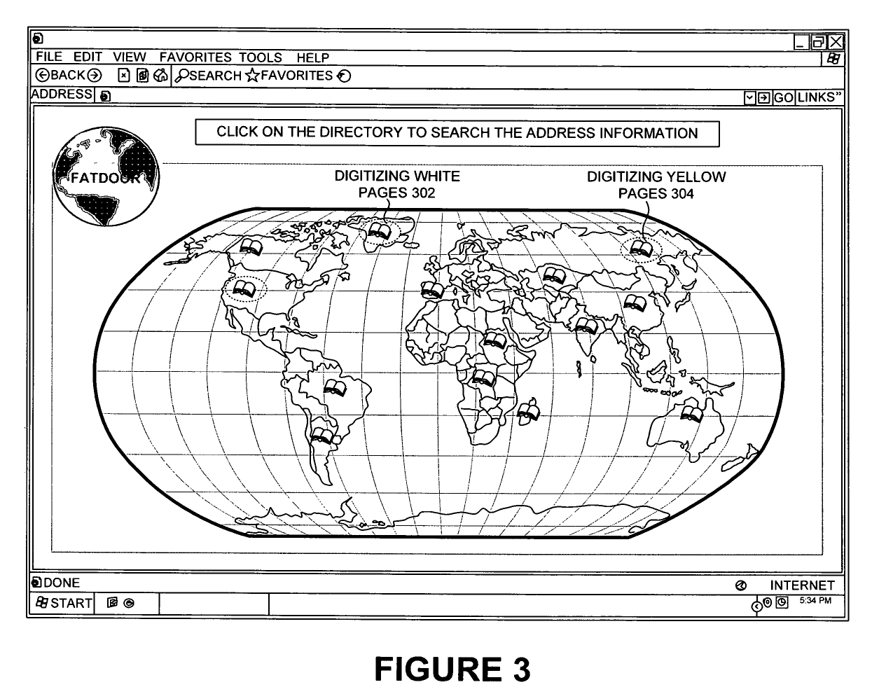

FIG. 3 is a global map view of digitizing white pages 302 and digitizing yellow pages 304, according to one embodiment. The digitizing white pages 302 may enable any user of the geo-spatial directory 100 to view the listing associated with the residents in the specific region on the globe. The digitizing yellow pages 304 may enable the user associated with the businesses to view the listing(s) in the specific region over the globe.

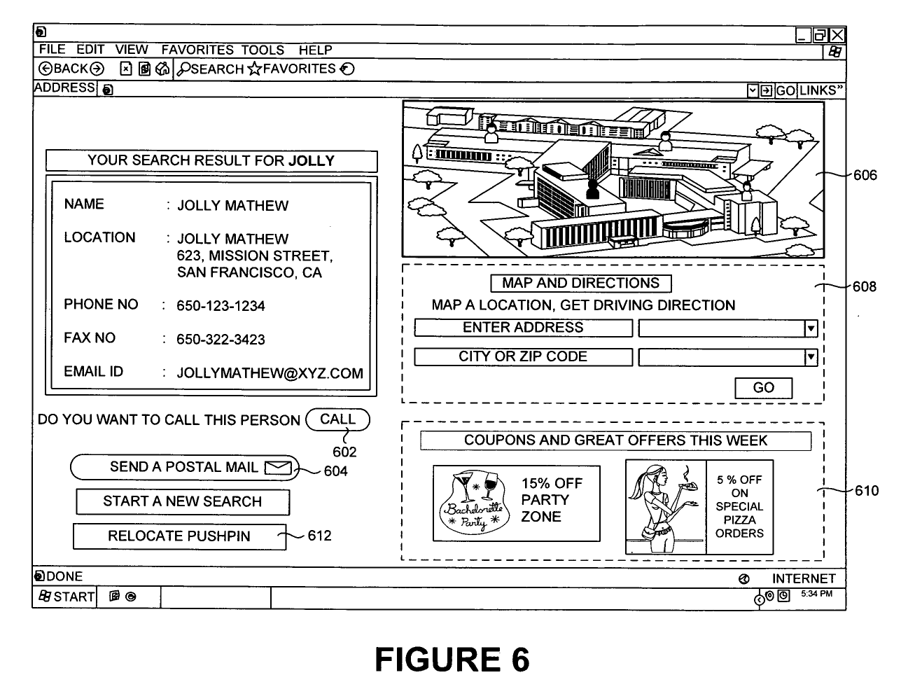

In the example embodiment illustrated in FIG. 3, the global map view may offer geo-spatially tagged information associated with the residents and/or businesses in the neighborhood through the digitized yellow pages and white pages of the world. One of the set of pushpins representing each of specific listings of a legacy telephone directory may be relocated (e.g., using the relocate pushpin option 612 of FIG. 6) through a wiki interface such that users of the wiki interface alter a position estimate (e.g., generated and visualized through a block interpolation algorithm) to a more accurate rooftop location of a particular listing in the legacy telephone directory now transformed into the geo-spatial directory (e.g., the geo-spatial directory 100 of FIG. 1).

The directions (e.g., the walking directions, the driving directions, the commuting directions, the subway route and timing directions, the bus route and timing directions, the train route and timing directions, and/or a plane route and timing directions, etc.) may be generated between a user (e.g., the user 132 of FIG. 1) of the geo-spatial directory 100 and the listing based on a stored address data (e.g., stored in the database 114 of FIG. 1) associated with a profile of the user in the geo-spatial directory (e.g., the geo-spatial directory 100 of FIG. 1) that determines a starting location of the user without requiring input of the starting location of the user when generating the directions.

FIG. 4 is a user interface view of the white pages in the geo-spatial directory 100, according to one embodiment. Particularly, FIG. 4 illustrates a map view 402, a search option 404, a search result option 406, an add contacts option 408 and an edit contacts option 410, according to one embodiment. The map view 402 may represent a three-dimensional neighborhood map (e.g., of the neighborhoods 130A-N of FIG. 1, in a geospatial environment, etc.) which visualizes profiles containing information of geo-coded locations associated with the listings in the geo-spatial environment. The map view 402 may also visualize the set of pushpins representing the specific listing in the geo-spatial directory 100.

The search option 404 may allow the users of the geo-spatial directory 100 to search the address data listed in the white pages. The search result option 406 may display results of the search requested by the users of the geo-spatial directory 100. The add contacts option 408 and the edit contacts option 410 may enable the users of the geo-spatial directory 100 to add and modify the address data associated with the profiles and listings of the residents in the neighborhood until the profiles are claimed by the legitimate entity.

In the example embodiment illustrated in FIG. 4, the user interface view enables the users of the geo-spatial directory 100 to search, find and connect the residents in the neighborhood through the neighborhood view in the map. An interface may be provided such that any visitor to the geo-spatial directory 100 automatically updates the address data and/or the listing through a wiki interface, and/or contributes content to the listing in the form of a photographic tag, a textual tag, and/or a video tag associated with the listing.

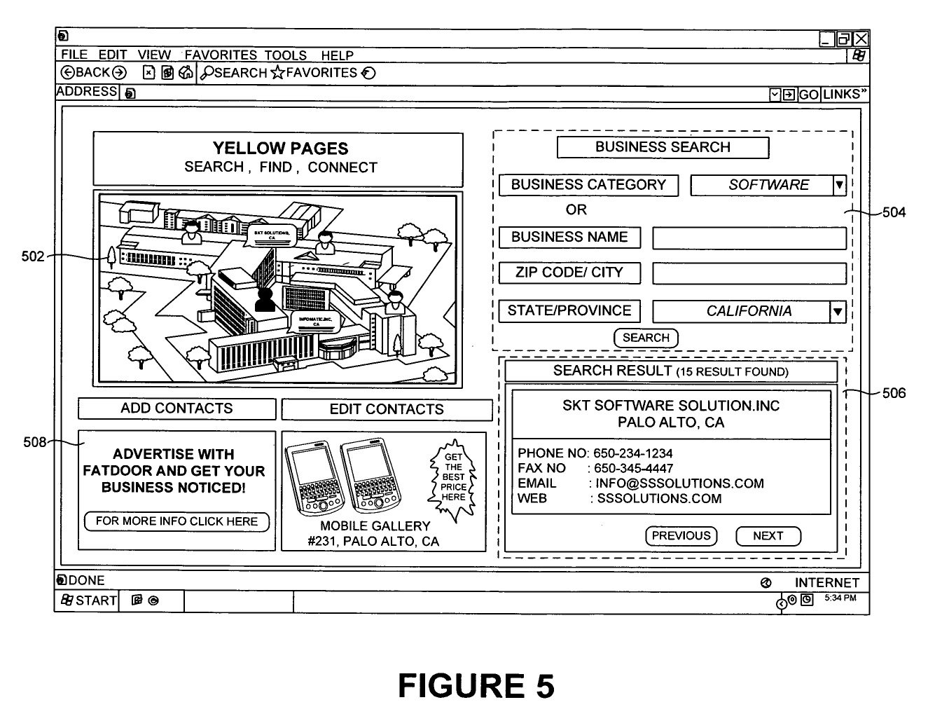

FIG. 5 is a user interface view of the yellow pages in a geo-spatial directory (e.g., the geo-spatial directory 100 of FIG. 1), according to one embodiment. Particularly, FIG. 5 illustrates a map view 502, a business search option 504, a search result option 506 and an option 508, according to one embodiment. The map view 502 may enable the users of the geo-spatial directory 100 to visualize the geo-coded locations associated with the businesses in the neighborhood on the three-dimensional neighborhood map.

The business search option 504 may enable the users of the geo-spatial directory 100 to search coupons, advertisements, businesses and/or other events located a threshold distance away in the neighborhood. The search result option 506 may display search results associated with the businesses requested by the users of the geo-spatial directory 100. The option 508 may enable the users associated with the businesses to contribute interesting data, advertisements, etc. to the listings of the geo-spatial directory 100 for the users to view them in the landing page. In the example embodiment illustrated in FIG. 5, the user interface view enables the users of the geo-spatial directory 100 to access the listing, the address data and the content data associated with the businesses in the neighborhood geo-coded on the map. The user interface view of the yellow page data enables the user to modify and/or add listings associated with the businesses in the neighborhood.

FIG. 6 is a user interface view of the information module 102 of FIG. 1, according to one embodiment. Particularly, FIG. 6 illustrates a call option 602, a send a postal mail option 604, a map view 606, a map and directions option 608, an option 610, and a relocate pushpin option 612, according to one embodiment. The call option 602 may enable the users of the geo-spatial directory (e.g., the geo-spatial directory 100 of FIG. 1) to communicate with the other users, residents and/or businesses associated with the listing in the geo-spatial directory 100. The send a postal mail option 604 may enable the users of the geo-spatial directory 100 to communicate with the residents and/or businesses of the neighborhood (e.g., through a direct mail builder application).

The map view 606 may enable the users of the geo-spatial directory 100 to visualize the neighborhood view in the map which displays the address data and/or the listing data associated with the profiles of the residents and/or businesses in the neighborhood. The map and directions option 608 may enable the users to get driving directions (e.g., a walking directions, a commuting directions, a driving directions, etc.) between the users and a particular listing associated with the businesses and/or residents, geo-spatially tagged in the geo-spatial database (e.g., the database 114 of FIG. 1).

The option 610 may enable the users of the geo-spatial directory 100 to view coupons, new events and/or activity provided by the residents and/or businesses in the neighborhood (e.g., the neighborhood 130A-N of FIG. 1). The relocate pushpin option 612 may enable the users of the geo-spatial directory 100 to relocate the set of pushpins, which represents the specific listings associated with the residents and/or businesses in the neighborhood.

In the example embodiment illustrated in FIG. 6, the user interface view facilitates the users of the geo-spatial directory 100 to explore the neighborhood and to communicate with the residents and/or businesses in the neighborhood through the call option 602 and the send a postal mail option 604. Also, the users can relocate the set of pushpins representing the specific listings in the neighborhood through the relocate pushpin option 612.

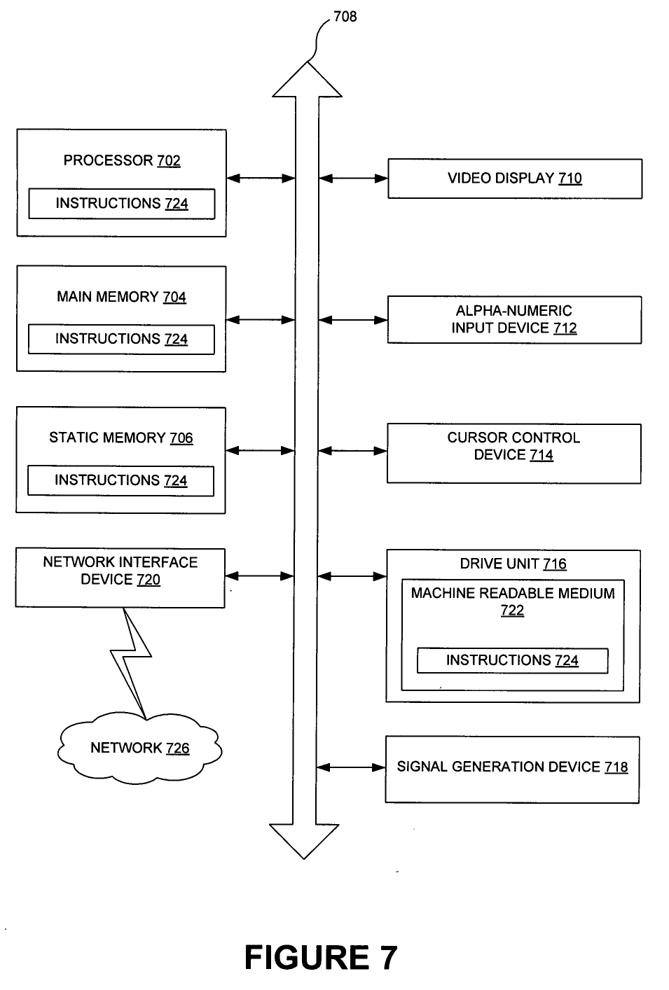

FIG. 7 is a diagrammatic system view 700 of a data processing system in which any of the embodiments disclosed herein may be performed, according to one embodiment. Particularly, the diagrammatic system view 700 of FIG. 7 illustrates a processor 702, a main memory 704, a static memory 706, a bus 708, a video display 710, an alpha-numeric input device 712, a cursor control device 714, a drive unit 716, a signal generation device 718, a network interface device 720, a machine readable medium 722, instructions 724, and a network 726, according to one embodiment.

The diagrammatic system view 700 may indicate a personal computer and/or the data processing system in which one or more operations disclosed herein are performed. The processor 702 may be a microprocessor, a state machine, an application specific integrated circuit, a field programmable gate array, etc. (e.g., Intel® Pentium® processor). The main memory 704 may be a dynamic random access memory and/or a primary memory of a computer system.

The static memory 706 may be a hard drive, a flash drive, and/or other memory information associated with the data processing system. The bus 708 may be an interconnection between various circuits and/or structures of the data processing system. The video display 710 may provide graphical representation of information on the data processing system. The alpha-numeric input device 712 may be a keypad, a keyboard and/or any other input device of text (e.g., a special device to aid the physically handicapped). The cursor control device 714 may be a pointing device such as a mouse.

The drive unit 716 may be a hard drive, a storage system, and/or other longer term storage subsystem. The signal generation device 718 may be a bios and/or a functional operating system of the data processing system. The network interface device 720 may be a device that may perform interface functions such as code conversion, protocol conversion and/or buffering required for communication to and from the network 726. The machine readable medium 722 may provide instructions on which any of the methods disclosed herein may be performed. The instructions 724 may provide source code and/or data code to the processor 702 to enable any one/or more operations disclosed herein.

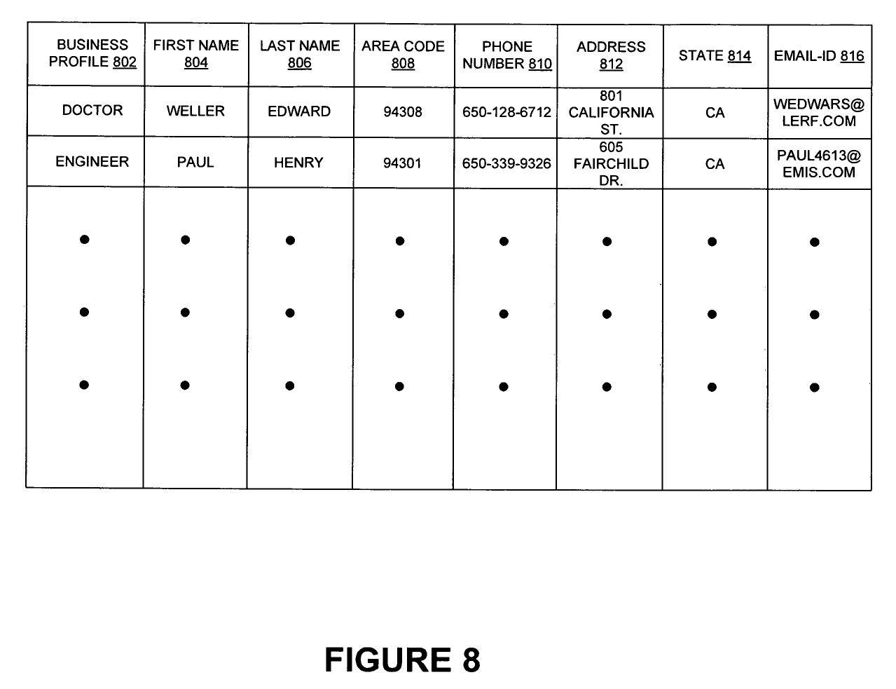

FIG. 8 is a table view 800 showing details of the listing associated with the businesses in the neighborhood, according to one embodiment. Particularly, FIG. 8 illustrates a business profile field 802, a first name field 804, a last name field 806, an area code field 808, a phone number field 810, an address field 812, a state field 814 and an email-id field 816, according to one embodiment.

The business profile field 802 may display the profiles associated with the businesses in the geo-spatial directory 100. The first name field 804 may display the first name of the businesses in the geo-spatial directory 100. The last name field 806 may display the last name of the businesses in the geo-spatial directory 100. The area code field 808 may display the area code associated with the businesses in the geo-spatial directory 100. The phone number field 810 may display the phone number(s) of the businesses in the geo-spatial directory 100. The address field 812 may display the address data associated with the listing of the businesses geo-coded on the map. The state field 814 may display the state in which the businesses are located in the geo-spatial directory 100. The email-id field 816 may display the email address information associated with the businesses in the geo-spatial directory 100.

In the example embodiment illustrated in FIG. 8, the business profile field 802 displays “Doctor” in the first row and “Engineer” in the second row of the business profile field 802 column. The first name field 804 displays “Weller” in the first row and “Paul” in the second row of the first name field 804 column. The last name field 806 displays “Edward” in the first row and “Henry” in the second row of the last name field 806 column.

The area code field 808 shows “94308” in the first row and “94301” in the second row of the area code field 808 column. The phone number field 810 shows “650-128-6712” in the first row and “650-339-9326” in the second row of the phone number field 810 column. The address field 812 displays “801 California ST” in the first row and “605 Fairchild DR” in the second row of the address field 812 column. The state field 814 displays “CA” in the first row and “CA” in the second row of the state field 814 column. The email-id field 816 displays “wedwars@lerf.com” in the first row and “paul4613@emis.com” in the second row of the email-id field 816 column.

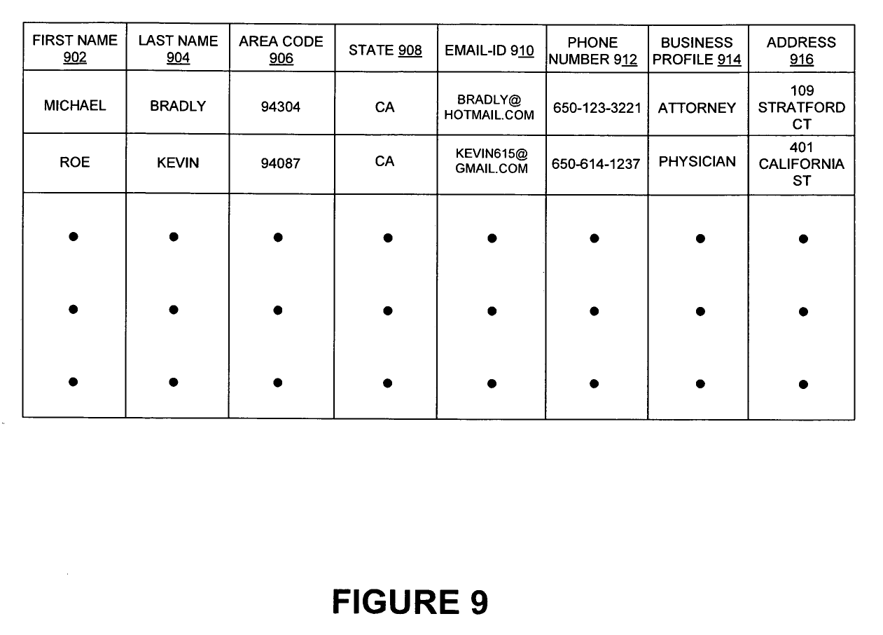

FIG. 9 is a table view 900 showing details of the geo-spatially tagged listings associated with the residential users in the neighborhood, according to one embodiment. Particularly, FIG. 9 illustrates a first name field 902, a last name field 904, an area code field 906, a state field 908, an email-id field 910, a phone number field 912, a business profile field 914, and an address field 916, according to one embodiment.

The first name field 902 may display the first names of the residential users associated with the listings in the geo-spatial directory 100. The last name field 904 may display the last names of the residential users in the geo-spatial directory 100. The area code field 906 may display the area code where the residence is located in the geo-spatial environment. The state field 908 may display the state in which the residential users are located. The email-id field 910 may display the email-id of the residential users geo-spatially tagged in the geo-spatial directory 100. The phone number field 912 may display phone numbers and/or contact information of the residential users in the geo-spatial directory 100. The business profile field 914 may display profiles of the residential users in the geo-spatial directory (e.g., additional information about the users, such as interests, hobbies, background, group affiliations, education, etc.). The address field 916 may display the address data of the residential user associated with the listing of the geo-spatial directory 100.

In the example embodiment illustrated in FIG. 9, the first name field 902 displays “Michael” in the first row and “Roe” in the second row of the first name field 902 column. The last name field 904 displays “Bradly” in the first row and “Kevin” in the second row of the last name field 904 column. The area code field 906 displays “94304” in the first row and “94087” in the second row of the area code field 906 column. The state field 908 displays “CA” in the first row and the second row of the state field 908 column.

The email-id field 910 displays “bradly@hotmail.com” in the first row and “kevin615@gmail.com” in the second row of the email-id field 910 column. The phone number field 912 displays “650-123-3221” in the first row and “650-614-1237” in the second row of the phone number field 912 column. The business profile field 914 displays “Attorney” in the first row and “Physician” in the second row of the business profile field 914 column. The address field 916 displays “109 Stratford CT.” in the first row and “401 California ST.” in the second row of the address field 916 column.

FIG. 10 is a schematic diagrammatic view of a directory scanner 1000, according to one embodiment. The directory scanner 1000 as illustrated in FIG. 10 may enable automatic scanning of the directory containing the listings and the address data (e.g., the listing of the telephone directory and the address data may be associated with the residents and/or businesses in the neighborhood) to be uploaded in the geo-spatial database. The directory scanner 1000 may automatically decouple the printed pages of the directory while scanning the directory containing the meta-data associated with the business and/or residents in the neighborhood. The directory scanner 1000 as illustrated in the example embodiment of FIG. 10 may also be used to perform the optical character recognition (e.g., OCR) methodology on the directory containing the listings that are geo-coded on the map (e.g., during scanning).

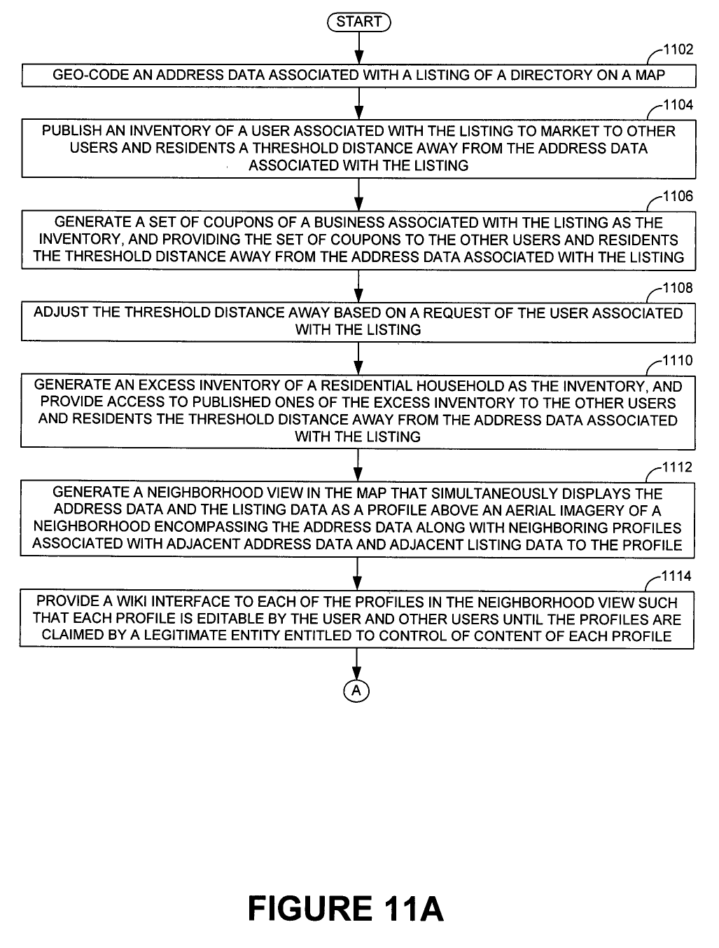

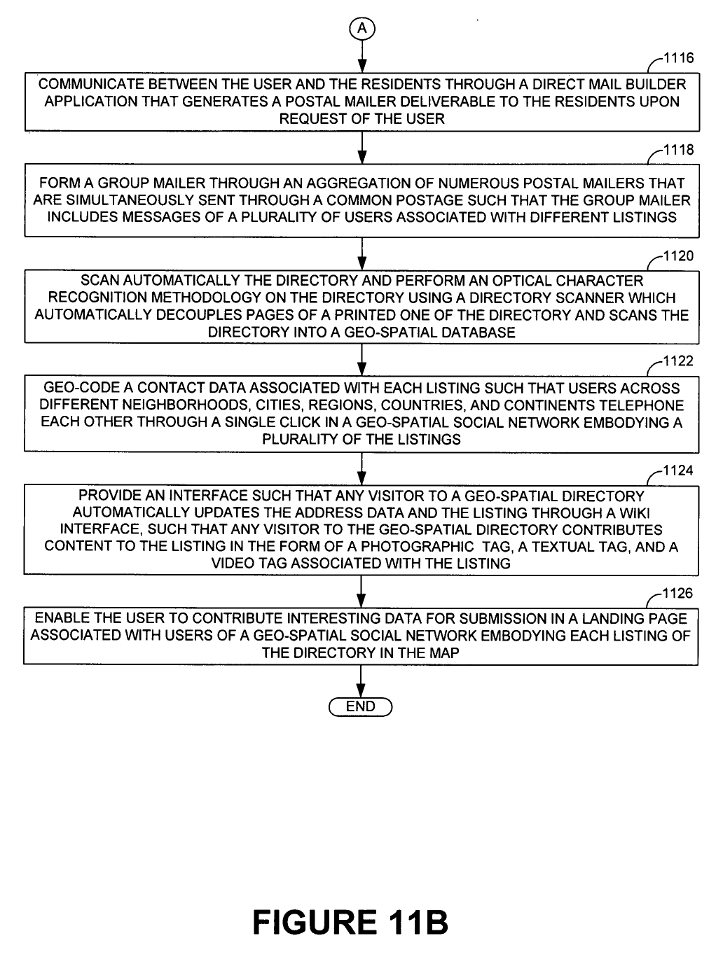

FIG. 11A is a process flow of geo-coding an address data associated with a listing of a directory on a map, according to one embodiment. In operation 1102, the address data associated with the listing of the directory (e.g., the directory 136 of FIG. 1) may be geo-coded on the map. In operation 1104, an inventory of a user (e.g., the user 132 of FIG. 1) associated with the listing may be published to market to other users and residents a threshold distance away from the address data associated with the listing. In operation 1106, a set of coupons of a business associated with the listing may be generated as the inventory, and provided to the other users and residents the threshold distance away from the address data associated with the listing. In operation 1108, the threshold distance away may be adjusted based on a request of the user associated with the listing.

In operation 1110, an excess inventory may be generated of a residential household as the inventory, and access may be provided to the published ones of the excess inventory to the other users and residents the threshold distance away from the address data associated with the listing. In operation 1112, a neighborhood view (e.g., the three-dimensional neighborhood map view 402 of FIG. 4) may be generated in the map that simultaneously displays the address data and the listing data as a profile above an aerial imagery of a neighborhood encompassing the address data along with neighboring profiles associated with adjacent address data and adjacent listing data to the profile. In operation 1114, a wiki interface (e.g., provided by the wiki module 110 of FIG. 1) may be provided to each of the profiles in the neighborhood view such that each profile is editable by the user and the other users until the profiles are claimed by a legitimate entity entitled to control of content of each profile.

FIG. 11B is a continuation of the process flow of FIG. 11A, showing additional processes, according to one embodiment. In operation 1116, there may be communication between the user and the residents through a direct mail builder application that generates a postal mailer deliverable to the residents upon a request of the user. In operation 1118, a group mailer may be formed through an aggregation of numerous postal mailers that are simultaneously sent through a common postage such that the group mailer includes messages of a plurality of users associated with different listings.

In operation 1120, the directory (e.g., the directory 136 of FIG. 1) may be scanned automatically and an optical character recognition methodology may be performed on the directory using a directory scanner which automatically decouples pages of a printed one of the directory and scans the directory into a geo-spatial database (e.g., the database 114 of FIG. 1). In operation 1122, a contact data associated with each listing may be geo-coded such that users across different neighborhoods, cities, regions, countries, and continents telephone each other through a single click in a geo-spatial social network embodying a plurality of the listings.

In operation 1124, an interface may be provided such that any visitor to a geo-spatial directory (e.g., the geo-spatial directory 100 of FIG. 1) automatically updates the address data and the listing through the wiki interface, and such that any visitor to the geo-spatial directory 100 contributes content to the listing (e.g., in the form of a photographic tag, a textual tag, and/or a video tag associated with the listing). In operation 1126, the user may be enabled to contribute interesting data for submission in a landing page associated with the users of the geo-spatial social network embodying each listing of the directory in the map.

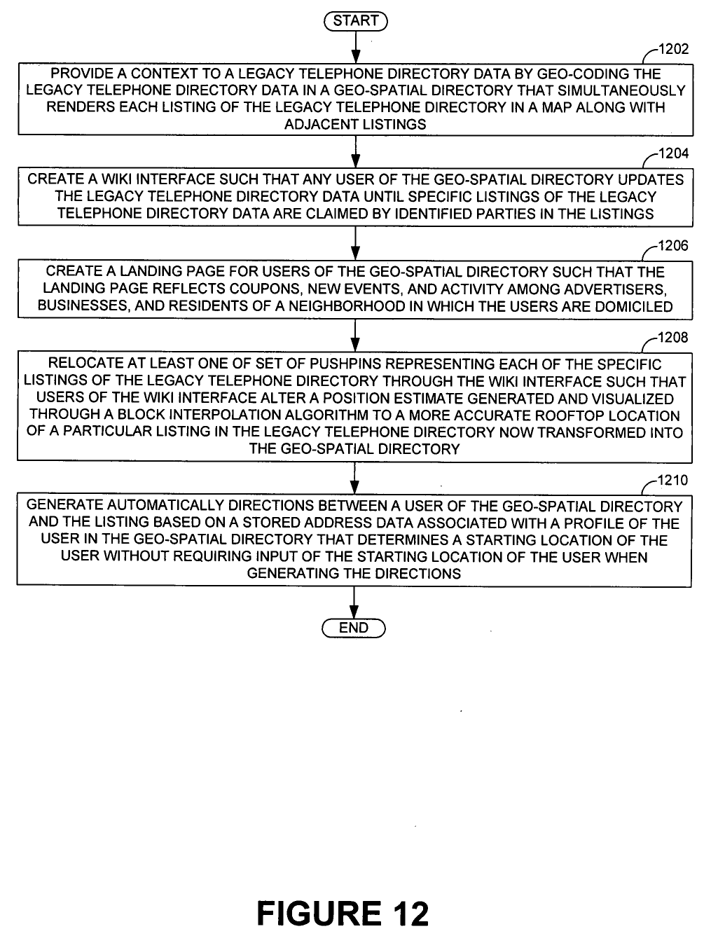

FIG. 12 is a process flow of geo-coding legacy telephone directory data in the geo-spatial directory (e.g., the geo-spatial directory 100 of FIG. 1), according to one embodiment. In operation 1202, a context may be provided to the legacy telephone directory data by geo-coding the legacy telephone directory data in the geo-spatial directory 100 that simultaneously renders each listing of the legacy telephone directory in a map along with adjacent listings. In operation 1204, a wiki interface may be created such that any user of the geo-spatial directory 100 updates the legacy telephone directory data until specific listings of the legacy telephone directory data is claimed by identified parties in the listing.

In operation 1206, a landing page may be created for users of the geo-spatial directory 100 such that the landing page reflects coupons, new events, and/or activity among advertisers, businesses, and/or residents of a neighborhood in which the users are domiciled. In operation 1208, a set of pushpins representing each of the specific listings of the legacy telephone directory may be relocated through the wiki interface such that users of the wiki interface alter a position estimate (e.g., generated and visualized through a block interpolation algorithm) to a more accurate rooftop location of a particular listing in the legacy telephone directory now transformed into the geo-spatial directory 100.

In operation 1210, directions between a user of the geo-spatial directory and the listing may be automatically generated based on a stored address data associated with a profile of the user in the geo-spatial directory (e.g., the geo-spatial directory 100) that determines a starting location of the user without requiring input of the starting location of the user when generating the directions.

Although the present embodiments have been described with reference to specific example embodiments, it will be evident that various modifications and changes may be made to these embodiments without departing from the broader spirit and scope of the various embodiments. For example, the various devices, modules, analyzers, generators, etc. described herein may be enabled and operated using hardware circuitry (e.g., CMOS based logic circuitry), firmware, software and/or any combination of hardware, firmware, and/or software (e.g., embodied in a machine readable medium). For example, the various electrical structure and methods may be embodied using transistors, logic gates, and electrical circuits (e.g., application specific integrated ASIC circuitry and/or in Digital Signal; Processor DSP circuitry).

For example, the information module 102, the search module 108, the wiki module 110, the map module 112, the landing module 134 and other modules of FIGS. 1-12 may be embodied through an information circuit, a search circuit, a wiki circuit, a map circuit, a landing circuit, and other circuits using one or more of the technologies described herein.

In addition, it will be appreciated that the various operations, processes, and methods disclosed herein may be embodied in a machine-readable medium and/or a machine accessible medium compatible with a data processing system (e.g., a computer system), and may be performed in any order. Accordingly, the specification and drawings are to be regarded in an illustrative rather than a restrictive sense.

What is claimed is:

1. A method comprising:
geo-coding an address data associated with a listing of a directory on a map; and
publishing an inventory of a user associated with the listing to market to other users and residents a threshold distance away from the address data associated with the listing.

2. The method of claim 1 further comprising generating a set of coupons of a business associated with the listing as the inventory, and providing the set of coupons to the other users and residents the threshold distance away from the address data associated with the listing.

3. The method of claim 2 further comprising adjusting the threshold distance away based on a request of the user associated with the listing.

4. The method of claim 1 further comprising generating an excess inventory of a residential household as the inventory, and providing access to published ones of the excess inventory to the other users and residents the threshold distance away from the address data associated with the listing.

5. The method of claim 1 wherein the directory is at least one of a people directory, a business directory, a telephone directory, a yellow page directory, a white page directory, and an address directory.

6. The method of claim 1 further comprising generating a neighborhood view in the map that simultaneously displays the address data and the listing data as a profile above an aerial imagery of a neighborhood encompassing the address data along with neighboring profiles associated with adjacent address data and adjacent listing data to the profile.

7. The method claim 6 further comprising providing a wiki interface to each of the profiles in the neighborhood view such that each profile is editable by the user and the other users until the profiles are claimed by a legitimate entity entitled to control of content of each profile.

8. The method of claim 7 wherein the legitimate entity is at least one of a business user and a residential user whose information is represented in the profile.

9. The method of claim 1 further comprising communicating between the user and the residents through a direct mail builder application that generates a postal mailer deliverable to the residents upon a request of the user.

10. The method of claim 9 further comprising forming a group mailer through an aggregation of numerous postal mailers that are simultaneously sent through a common postage such that the group mailer includes messages of a plurality of users associated with different listings, and wherein the group mailer is at least one of a coupon book, a specials guide, a community publication, a political mailer, and an advertisement.

11. The method of claim 1 further comprising automatically scanning the directory and performing an optical character recognition methodology on the directory using a directory scanner which automatically decouples pages of a printed one of the directory and scans the directory into a geo-spatial database.

12. The method of claim 1 further comprising geo-coding a contact data associated with each listing such that users across different neighborhoods, cities, regions, countries, and continents telephone each other through a single click in a geo-spatial social network embodying a plurality of the listings.

13. The method of claim 1 further comprising providing an interface such that any visitor to a geo-spatial directory automatically updates the address data and the listing through a wiki interface, and such that any visitor to the geo-spatial directory contributes content to the listing in the form of a photographic tag, a textual tag, and a video tag associated with the listing.

14. The method of claim 13 further comprising enabling the user to contribute interesting data for submission in a landing page associated with users of a geo-spatial social network embodying each listing of the directory in the map.

15. The method of claim 1 in a form of a machine-readable medium embodying a set of instructions that, when executed by a machine, causes the machine to perform the method of claim 1.

16. A method comprising:
providing a context to a legacy telephone directory data by geo-coding the legacy telephone directory data in a geo-spatial directory that simultaneously renders each listing of the legacy telephone directory in a map along with adjacent listings;
creating a wiki interface such that any user of the geo-spatial directory updates the legacy telephone directory data until specific listings of the legacy telephone directory data are claimed by identified parties in the listings; and
creating a landing page for users of the geo-spatial directory such that the landing page reflects coupons, new events, and activity among advertisers, businesses, and residents of a neighborhood in which the users are domiciled.

17. The method of claim 16 further comprising relocating at least one of set of pushpins representing each of the specific listings of the legacy telephone directory through the wiki interface such that users of the wiki interface alter a position estimate generated and visualized through a block interpolation algorithm to a more accurate rooftop location of a particular listing in the legacy telephone directory now transformed into the geo-spatial directory.

18. The method of claim 16 further comprising automatically generating directions between a user of the geo-spatial directory and the listing based on a stoaddress data associated with a profile of the user in the geo-spatial directory that determines a starting location of the user without requiring input of the starting location of the user when generating the directions, wherein the directions are at least one of a walking directions, a driving directions, a commuting directions, a subway route and timing directions, a bus route and timing directions, a train route and timing directions, and a plane route and timing directions.

19. A system, comprising:
an information module having a yellow page data and a white page data that is geo-spatially tagged in a geo-spatial directory;
a scanning device to transform a telephone directory into a form that is geo-spatially tagged in the geo-spatial directory;
a wiki module to make editable each listing of the telephone directory until each listing is claimed; and
a map module to simultaneously display adjacent locations listed in the telephone directory in a three-dimensional map view taken through at least one of aerial photography and satellite imagery.

20. The system of claim 19 further comprising a landing module to generate a home page of a neighbor who logs into the geo-spatial directory to learn about and explore new and changing events in their neighborhood, wherein the new and changing events are at least one of new people in a neighborhood, users who have viewed a profile of the neighbor, and changing business profiles and special offers in the neighborhood.
